(19) United States
(12) Patent Application Publication
(10) Pub. No.: US 2015/0151635 A1
(43) Pub. Date: Jun. 4, 2015

(54) VEHICLE

(71) Applicant: YANMAR CO., LTD., Osaka-shi, Osaka (JP)

(72) Inventors: Yoshiaki Kurokawa, Osaka-shi (JP); Takayuki Tokuhara, Osaka-shi (JP)

(73) Assignee: YANMAR CO., LTD., Osaka-shi, Osaka (JP)

(21) Appl. No.: 14/402,283

(22) PCT Filed: Dec. 12, 2012
(86) PCT No.: PCT/JP2012/082252

§ 371 Date: Nov. 19, 2014

(30) Foreign Application Priority Data
Jun. 13, 2012 (JP) 2012-134263

(51) Int. Cl. B60K 23/02; G05G 1/30; G05G 1/04; G05G 7/04

(52) U.S. Cl. CPC B60K 23/02; G05G 7/04; G05G 1/30; G05G 1/04

(57) ABSTRACT

A vehicle is provided with a clutch pedal which, when depressed, interrupts the transmission of drive power from the engine to the drive wheels. The clutch pedal is constituted by a pedal section and an arm having the pedal section attached to the lower part thereof. The arm can swing about the upper part thereof and is connected to a clutch disk within a transmission through a link mechanism. An elastic member is provided between the arm and a machine body. The vehicle is configured in such a manner that when the clutch pedal is depressed, the elastic member acts in a pressing-back direction until the clutch pedal reaches a first predetermined position, the pressing-back direction being the direction in which the elastic member presses back the arm; when the clutch pedal is depressed beyond the first predetermined position, the elastic member acts in the direction in which the arm is pressed in; and when the clutch pedal is depressed up to a second predetermined position, the clutch disk is separated. One end of the elastic member is mounted to the intermediate position of the arm, and the other end of the elastic member is mounted to the machine body.

### TECHNICAL FIELD

The present invention relates to vehicles in which the transmission of drive power from the engine to drive wheels is interrupted by depressing a clutch pedal.

### BACKGROUND ART

Since depressing a clutch pedal requires relatively strong force, a technique as disclosed in Patent Literature 1 has been proposed for a vehicle with a clutch pedal. In Patent Literature 1, a gas spring is provided between an arm portion with a clutch pedal attached to the lower end thereof and a frame to which the clutch is attached, the frame rotatably supporting the upper end of the arm portion. In this structure, the gas spring acts as repulsive force until the clutch pedal is depressed for a fixed amount. When the depression exceeds the fixed amount, the gas spring acts as assist force. Accordingly, unnecessary depression of the clutch pedal can be prevented by the repulsive force at an early stage of depression, while a clutch switching operation can be facilitated by the assist force at a later stage of depression.

### CITATION LIST

### Patent Literature

Patent Literature 1: JP 2002-181075 A

### SUMMARY OF INVENTION

### Technical Problem

In Patent Literature 1, one end of the gas spring is attached to the lower part of the arm portion. Therefore, the clutch pedal and the gas spring are positioned close to each other, causing a problem of damage of the gas spring with the foot of a driver that abuts against the gas spring by mistake when the driver puts the foot on and depresses the clutch pedal.

In this type of vehicle, a reverser lever for switching between forward and backward movements (forward and backward movement switching lever), as disclosed in JP 7-132752 A, is arranged around a circular steering wheel and rotated along the outer periphery of the steering wheel to an arc drawing manner in a forward or backward direction, to thereby operate a reverser clutch in a transmission case. An arcuate movement of such a reverser lever is transmitted via a link mechanism to operate a reverser clutch (forward and backward switching means) in the transmission case.

An example of a method for converting the arcuate rotational movement of the reverser lever into vertical movement is to provide a transmission arm projecting on a plane perpendicular to the center of rotation of a first rotation shaft, which is provided at the base end of the reverser lever, and also provide a lug projecting downward from one end of the transmission arm. A connecting rod whose center line runs in a direction perpendicular to the center line of the first rotation shaft is provided to be engaged with the lug of the transmission arm around the connecting rod. The lug is configured to rotate the connecting rod in response to the rotation of the transmission arm.

In addition, a second rotation shaft is provided in parallel with the center line of rotation of the connecting rod at the lower part thereof. The second rotation shaft is connected with an operation arm and acts as a center of rotation of the operation arm. The operation arm is connected to the upper end of the link mechanism. When the reverser lever is rotated arcuately along the outer periphery of the steering wheel, the movement is transmitted to the link mechanism as the vertical movement. Then, an operation shaft of the reverser clutch is rotated when the arm connected to the link mechanism rotates vertically. Such a structure, however, requires two rotation shafts of the first and second rotation shafts having different centers of rotation in different directions to transmit the movement of the reverser lever to operate the reverser clutch, which lead to a complicated structure.

An object of the present invention, therefore, is to provide a vehicle allowing safe operation of a clutch and capable of switching between forward and backward movements by a simple structure.

### Solution to Problem

According to an embodiment of the present invention as recited in claim 1, a vehicle includes a clutch pedal which, when depressed, interrupts the transmission of drive power from the engine to the drive wheels. The clutch pedal is constituted by a pedal section and an arm portion having the pedal section attached to the lower part thereof. The arm portion can rotate about the upper part thereof and is connected to a clutch disk within a transmission through the link mechanism. An elastic member is provided between the arm portion and a machine body. When the clutch pedal is depressed, the elastic member acts in a pressing-back direction until the clutch pedal reaches a first predetermined position, the pressing-back direction being the direction in which the elastic member presses back the arm portion. When the clutch pedal is depressed beyond the first predetermined position, the elastic member acts in the direction in which the arm portion is pressed. When the clutch pedal is depressed up to a second predetermined position, the clutch disk is separated. In such a vehicle, one end of the elastic member is mounted to an intermediate position of the arm portion, and the other end of the elastic member is mounted to the machine body.

According to the embodiment of the present invention as recited in claim 2, a shielding is provided at the rear end of a bonnet for separating the bonnet from a driver seat in the vehicle as recited in claim 1. The other end of the elastic member is attached to the shielding.

According to the embodiment of the present invention as recited in claim 3, the shielding is provided with an attaching member in the vehicle as recited in claim 2. The attaching member includes a forward and backward movement switching lever that switches between forward and backward operations of the vehicle via link means. The forward and backward movement switching lever includes operation means for driving forward and backward switching means in a mission case. When the forward and backward switching lever is operated, the link means is enabled to rotate in a forward or backward direction of the vehicle about a support point of rotation.

### Advantageous Effects of Invention

According to the embodiment of the present invention as recited in claim 1, the vehicle includes the clutch pedal which, when depressed, interrupts the transmission of drive power from the engine to the drive wheels. The clutch pedal is constituted by the pedal section and the arm portion having the pedal section attached to the lower part thereof. The arm portion can rotate about the upper part thereof and is connected to the clutch disk within the transmission through the link mechanism. The elastic member is provided between the arm portion and the machine body. When the clutch pedal is depressed, the elastic member acts in a pressing-back direction until the clutch pedal reaches the first predetermined position, the pressing-back direction being the direction in which the elastic member presses back the arm portion. When the clutch pedal is depressed beyond the first predetermined position, the elastic member acts in the direction in which the arm portion is pressed in. When the clutch pedal is depressed up to a second predetermined position, the clutch disk is separated. In such a vehicle, one end of the elastic member is mounted to the intermediate position of the arm portion, and the other end of the elastic member is mounted to the machine body.

Accordingly, the risk of damaging the elastic member with the foot of a driver that abuts against the elastic member by mistake when the driver puts the foot on and depress the clutch pedal can be eliminated. The clutch disk can be separated easily because the elastic member assists depression when the clutch pedal is depressed beyond the first predetermined position. It is possible, therefore, to provide a vehicle with a clutch pedal having excellent operability and allowing safe operation of the clutch. Further, the erroneous operation of the clutch pedal can be prevented, as the counterforce acts in the pressing-back direction at least up to the first predetermined position when the driver depresses the clutch pedal by mistake.

According to the embodiment of the present invention as recited in claim 2, the shielding is provided at the rear end of the bonnet for separating the bonnet from a driver seat, with the other end of the elastic member attached to the shielding. The shielding decreases transmission of heat discharged from the engine, and such a shielding can also be used to mount the elastic member to provide a vehicle with a reduced number of parts.

According to the embodiment of the present invention as recited in claim 3, the attaching member is provided at the shielding, the attaching member including the forward and backward movement switching lever for switching between forward and backward operations of the vehicle via the link means. The forward and backward movement switching lever includes the operation means for driving forward and backward switching means in the mission case. When the forward and backward switching means is operated, the link means is enabled to rotate in a forward or backward direction of the vehicle about a support point of rotation.

Accordingly, the forward and backward switching lever can tilt in a generally linear direction in a forward or backward direction of the vehicle about the support point of rotation of the link means. It is possible, therefore, to provide a farm working vehicle capable of switching between the forward and backward movements by a simple structure. Since the forward and backward switching lever can include only one support point of rotation, the operation of the forward and backward switching lever can be simplified to improve operability.

### BRIEF DESCRIPTION OF DRAWINGS

FIG. 1 is a perspective view of a tractor as an example of a vehicle according to the present invention.

FIG. 2 is a side view of a main part of the present application.

FIG. 3 is a perspective view of a main part of the present application.

FIG. 4A is a side view of an upper part of a clutch pedal, and FIG. 4B is a plan view thereof.

FIG. 5A is a rear view of a lower part of an air cut plate, and FIG. 5B is a side view thereof.

FIGS. 6A to 6C are side views illustrating depression of a clutch pedal, in which FIG. 6A illustrates the start of depression, FIG. 6B illustrates a state where a first predetermined position is reached, and FIG. 6C illustrates a state where the direction of a rod portion of the gas spring switches from a shrinking direction to an expanding direction beyond the first predetermined position.

FIG. 7 is a timing chart illustrating the relation of the amount of depression of the clutch pedal, pedaling force, and an active force from the gas spring.

FIG. 8 is a perspective view illustrating how a reverser lever is attached.

FIG. 9A is a plan view for explaining how the reverser lever is connected to a reverser lever link, and

FIG. 9B is a side view when seen from a direction of an arrow A of FIG. 9A.

FIG. 10 is a side view when seen from a direction of an arrow B of FIG. 9A for explaining how the reverser lever is connected to the reverser lever link.

FIG. 11 is a perspective view of a post supporting member that supports a steering post from below.

FIG. 12 is an explanatory view illustrating how the reverser lever, the reverser lever link, an operation arm, and a transmission case are connected with each other.

FIG. 13A is a plan view for explaining the shaft part of the reverser lever put in a guide hole of the reverser lever, FIG. 13B is a side view thereof, and FIG. 13C is a schematic plan view for explaining a positional relation between the reverser lever and a steering wheel.

FIG. 14A is a plan view illustrating a main part of another example of a reverser lever, and FIG. 14B illustrates a side view when seen from an arrow C of FIG. 14A.

FIG. 15 is a perspective view illustrating a main part of another example of the reverser lever.

FIG. 16 is an explanatory view illustrating how a stopper restricts rotation of a link member.

### DESCRIPTION OF EMBODIMENTS

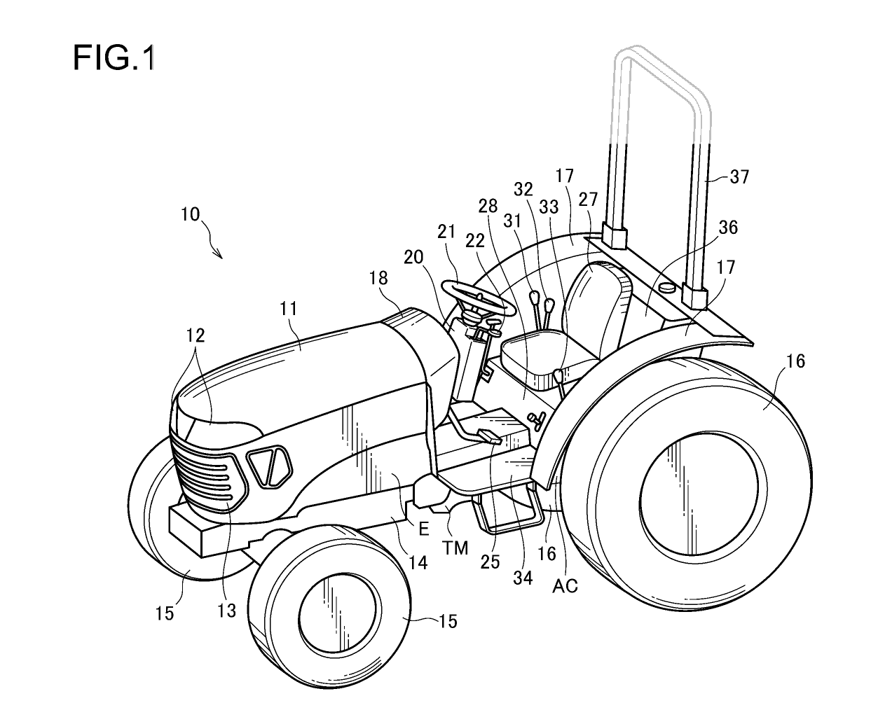

An embodiment of the present invention will be described in detail below by referring to the accompanying drawings. In the description below, “front” refers to a direction of forward movement of a tractor (vehicle with a clutch pedal) 10, “rear” refers to a direction of backward movement of the tractor 10, and “right and left” refers to the right and left directions relative to the direction of the tractor 10 moving forward. FIG. 1 is a perspective view of a tractor 10 with a clutch pedal according to an embodiment of the present invention. The tractor 10 includes an engine (drive unit) E, a radiator, a cooling fan, an air cleaner, a battery, etc., in a bonnet 11. In the front part of the bonnet 11, headlights 12 and a front grille 13 are provided for taking outside air into the engine. The engine E, the radiator, and the battery are mounted on a chassis (machine body) 14. The machine body also includes, in addition to the chassis 14, a transmission, a braking mechanism (which will be described later), and so on, which are connected with each other by bolts or the like. Front wheels 15, 15 are provided laterally in the front part of the machine body, while rear wheels 16, 16 are provided laterally in the rear part of the machine body. Fenders 17, 17 are provided to cover the right and left rear wheels (drive wheels) 16, respectively, from above and from the inside.

In the rear part of the bonnet 11, a dashboard 18 is provided via an air cut plate (shielding) which will be described in detail later. The dashboard 18 includes a panel that displays speed, a remaining fuel amount, etc. A steering column cover 20 is provided adjacent to and behind the dashboard 18. A steering wheel 21 is provided in a projecting manner at the upper end of the steering column cover 20. On the surface of the steering column cover 20, a reverser lever 22 is provided on the left side of the steering wheel 21, and an acceleration lever is provided on the right side of the steering wheel (operation unit) 21. Right and left brake pedals are provided in the lower right side of the steering column cover 20, and a clutch pedal 25 is provided in the lower left side of the steering column cover 20.

A driver seat (operation unit) 27 is provided behind the steering column cover 20 at a fixed distance therefrom. The driver seat 27 is arranged between the right and left fenders 17, 17. The driver seat 27 is mounted on a driving cab 28. A hydraulic lift lever 31 and a PTO lever 32 are provided on the right side of the top face of the driving cab 28. A sub shift lever 33 is provided on the left side of the top face of the driving cab 28. A main shift lever is provided on the right side of the front face of the driving cab 28, and a 4WD lever is provided on the left side of the front face of the driving cab 28.

A floor 34 is provided between the driving cab 28 and the bonnet 11. The floor 34 is provided for a driver to put the foot on when the driver steps on an off the tractor 10 or during driving the tractor 10. A transmission case TM that stores transmission is arranged below the floor 34. The transmission case TM is fixed in the rear part of the chassis 14. Power from the engine E is transmitted to the rear wheels 16 via the transmission.

A fuel tank 36 is arranged adjacent to and behind the driver seat 27. The fuel tank 36 is arranged between the right and left fenders 17, 17. A roll-over protective structures (ROPS) 37 is provided in a projecting manner at the rear end of the right and left fenders 17, 17. The ROPS 37 is fixed with an axle case AC of the rear wheels 16. The axle case AC is fixed with the transmission case TM.

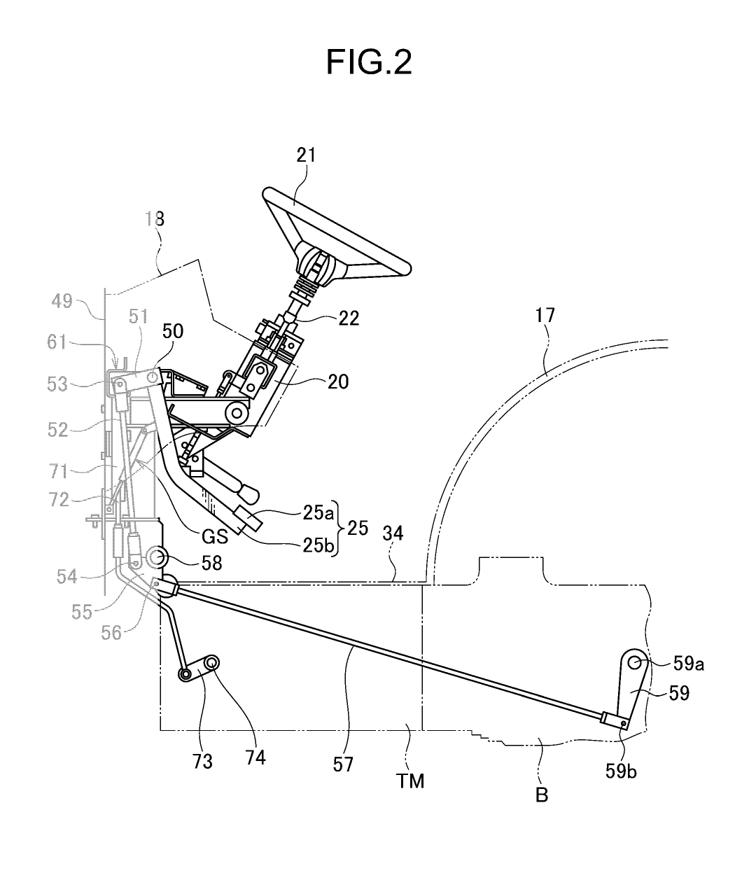

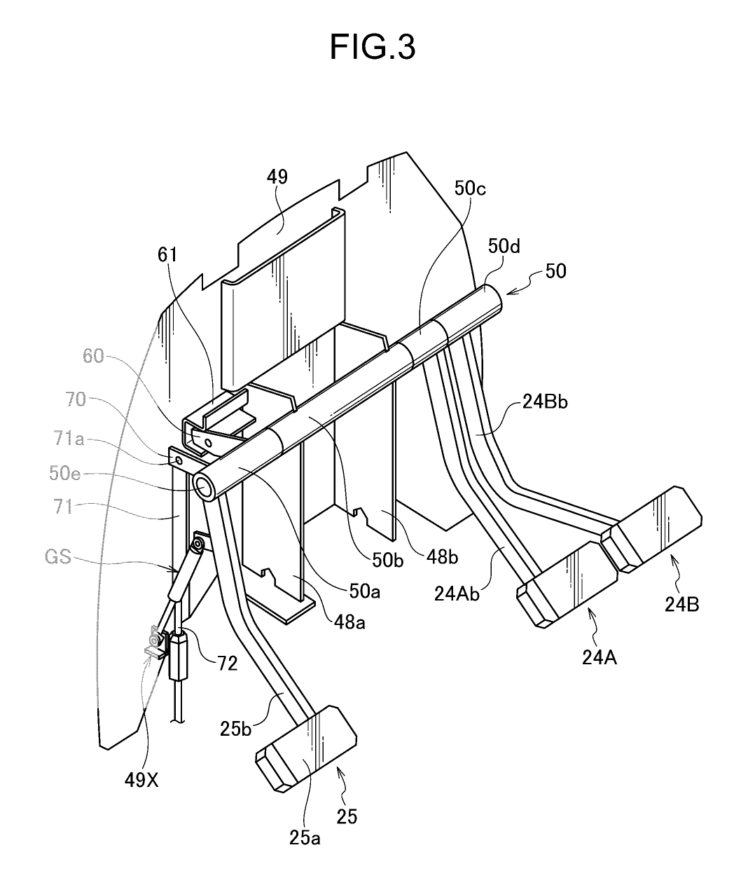

FIGS. 2 and 3 are side views of a main part of the present example. In this case, the tractor 10 includes right and left brake pedals 24A, 24B and a clutch pedal 25. The brake pedals 24A, 24B and the clutch pedal 25 are attached to a first rotation shaft 50.

The first rotation shaft 50 includes an internal rod 50e, and a left end portion 50a, a center portion 50b, a right side portion 50c, and a right end portion 50d of a cylinder externally provided over the rod 50e. The right side portion 50c of the cylinder is fixedly attached to the rod 50e. The left end portion 50a and the right end portion 50d of the cylinder are rotatably supported by the rod 50e. The center portion 50b of the cylinder is fixedly attached to brackets 48a, 48b, which will be described later, to rotatably support the rod 50e. Accordingly, when the right side portion 50c of the cylinder rotates, the rod 50e alone rotates synchronously. A base end side of an arm portion 24Ab of the brake pedal 24A is fixedly attached to the right side portion 50c of the cylinder of the first rotation shaft 50. A base end side of an arm portion 24Bb of the brake pedal 24B is fixedly attached to the right end portion 50d of the first rotation shaft 50.

One end of a first link plate 51 is fixedly attached to the left end of the rod 50e. Thus, the first link plate 51 rotates synchronously with the right side portion 50c of the cylinder. Meanwhile, another link plate (which is not shown) is fixedly attached to the right end of the right end portion 50d of the cylinder by welding or the like. The link plate rotates synchronously with the right end portion 50d of the cylinder.

One end of a first link rod 52 is rotatably attached to the first link plate 51 via a pin 53. The first link rod 52 is formed by a metal rod having planar portions at both ends thereof at which the first link plate 51 is connected. The other end of the first link rod 52 is rotatably attached to one end of a second link plate 55 via a pin 54. The second link plate 55 is fixedly provided on the outer periphery of a second rotating portion 58.

The second rotating portion 58 is formed like a roller and includes an internal rod as a shaft. A cylindrical portion is fixedly provided on the outer periphery near the center of the shaft. The cylindrical portion is fixedly attached to the floor 34. One end of a second link rod 57 is rotatably attached to the other end of the second link plate 55 via a pin 56.

The other end of the second link rod 57 is rotatably connected to the tip end of an operation arm 59 via a pin 59b. The rear end of the operation arm 59 is rotatably attached to a braking mechanism B of the rear wheels 16 via a rotation shaft 59a. The operation arm 59 and the rotation shaft 59a are fixedly provided such that the rotation shaft 59a rotates along with the rotation of the operation arm 59. When the rotation shaft 59a rotates, the brake of the left rear wheels 16 works.

A link plate identical to the first link plate 51 that acts with the left brake pedal 24A is fixedly attached, by welding or the like, to the right end of the right end portion 50d of the cylinder connected to the right brake pedal 24B. Similarly to the above, the first link plate 51 that acts with the right brake pedal 24B has connected thereto the first link rod 52, the second link plate 55, the second rotating portion 58, the second link rod 57, and the operation arm 59. The operation arm 59 is rotatably attached to the braking mechanism B of the right rear wheel 16 via the rotation shaft 59a.

The clutch pedal 25 is constituted by a pedal section 25a and an arm portion 25b. The pedal section 25a is fixed on the upper side of the lower end portion of the arm portion 25b by a bolt or the like. The surface of the pedal section 25a is provided with slip prevention treatment (such as making unevenness or plastering rubber on the surface). The upper end of the arm portion 25b is fixedly attached to the left end portion 50a of the cylinder, and a first clutch link plate 70 is fixedly attached to the left end portion 50a of the cylinder. The clutch pedal 25 is connected with a clutch disk in the transmission TM via the link mechanism. The link mechanism includes a second clutch link plate 71, a clutch link rod 72, a clutch operation arm 73, a rotation shaft 74, etc.

The clutch link plate 70 is a rectangular metal plate, with one end thereof fixedly attached to the left end portion 50a of the cylinder of the first rotation shaft 50. The other end of the clutch link plate 70 is rotatably connected to the tip end of the second clutch link plate 71 via a pin 71a. The other end of the second clutch link plate 71 is fixedly attached to the tip end of the clutch link rod 72 by a bolt. The rear end of the clutch link rod 72 is rotatably connected to the tip end of the clutch operation arm 73 via a pin. The other end of the clutch operation arm 73 is fixedly attached to the rotation shaft 74. The rotation shaft 74 penetrates through the mission case TM and rotates along with the rotation of the clutch operation arm 73. The rotation of the rotation shaft 74 causes the main clutch, which is connected to the output shaft of the engine to be disconnected.

The brackets 48a, 48b are fixedly attached to the center portion 50b of the cylinder of the first rotation shaft 50. The first rotation shaft 50 is fixedly attached to the air cut plate (shielding plate) 49 via the brackets 48a, 48b. Since the first rotation shaft 50 is provided across the air cut plate 49 in a width direction thereof, the rigidity of the air cut plate 49 is strengthened by the first rotation shaft 50.

A stopper arm 60 is further provided fixedly at the left end portion 50a of the cylinder of the first rotation shaft 50. The stopper arm 60 is configured to restrict a rotation range of the clutch pedal 25. The tip end of the stopper arm 60 is arranged in a clutch stopper 61. The tip end of the stopper arm 60 is allowed to move vertically within a predetermined range in the clutch stopper 61 along with the movement of the clutch pedal 25. The clutch stopper 61 is fixed to the air cut plate 49 by welding.

Meanwhile, the upper end of a gas spring (elastic member) GS is attached at a position of the arm portion 25b slightly upper side from the center (intermediate position of the arm portion) of the clutch pedal 25. The lower end of the gas spring GS is attached to the bracket 49X fixedly attached to the air cut plate 49. The air cut plate 49 is fixed to the upper end of the transmission case (machine body) TM via the brackets 48a, 48b.

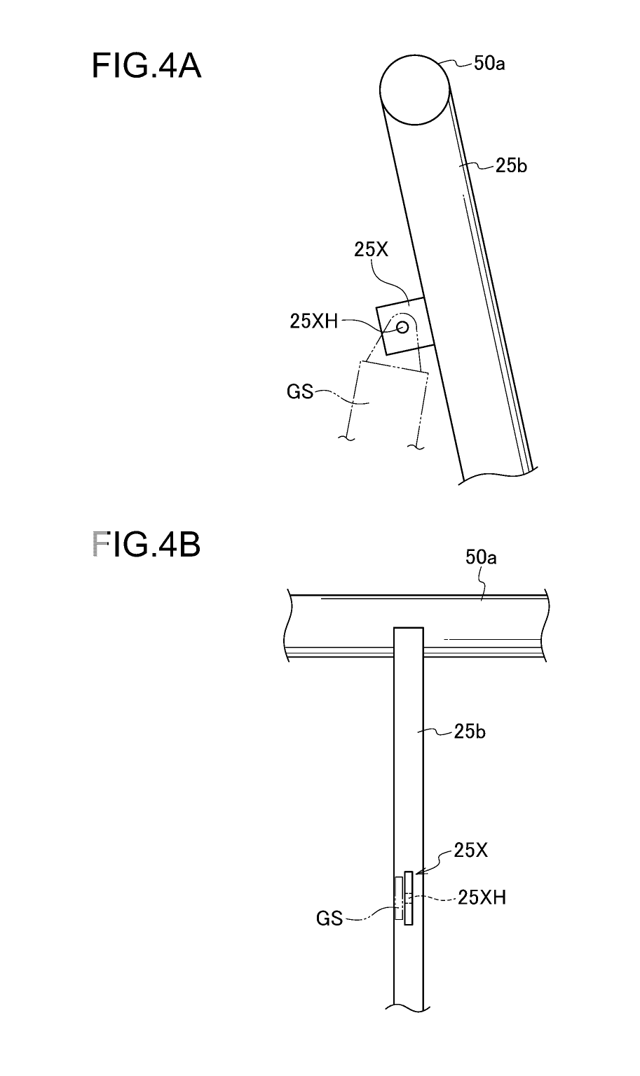

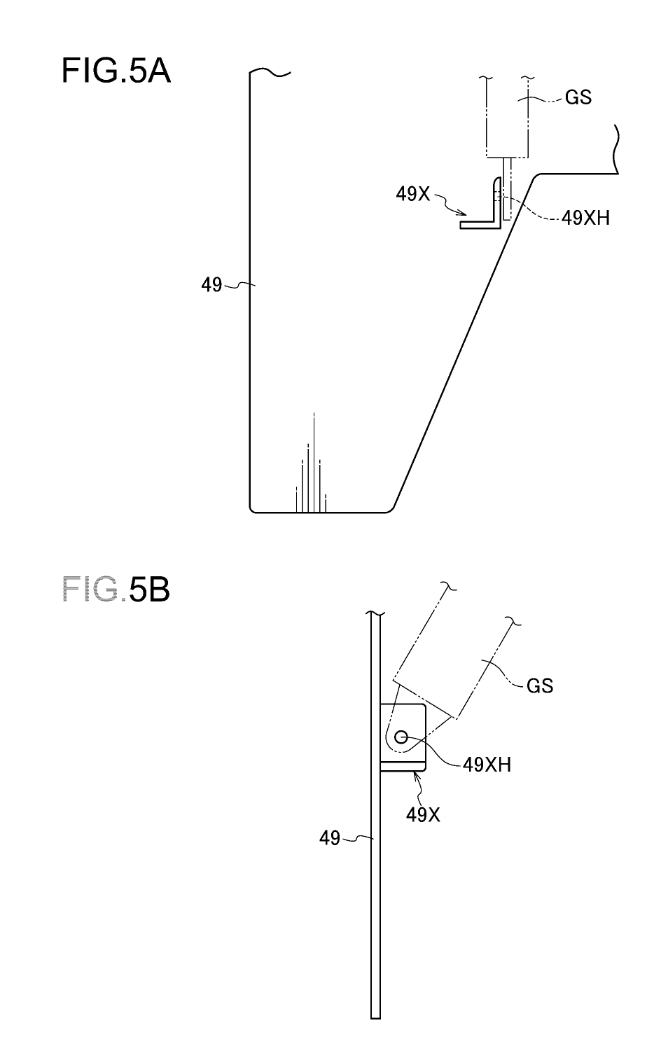

Specifically, as illustrated in FIGS. 4 and 5, a rectangular stay 25X made from a metal plate is fixedly attached, by welding or the like, to nearly the center of the thick plate arm portion 25b in a thickness direction. A through hole 25XH is formed at nearly the center of the stay 25X. The through hole 25XH is combined with a through hole formed at the upper end of the gas spring GS and fixed to each other by a rivet pin or the like. The gas spring GS is rotatably attached to the stay 25X.

A bracket 49X is fixedly attached to the left lower portion of the air cut plate 49. The bracket 49X is formed by a metal plate that is folded in an L shape when seen from the side. A through hole 49XH is formed in the center portion of a vertical surface of the bracket 49X. The through hole 49XH is combined with a through hole formed at the lower end of the gas spring GS, and fixed to each other by a rivet pin or the like. The gas spring GS is rotatably attached to the bracket 49X.

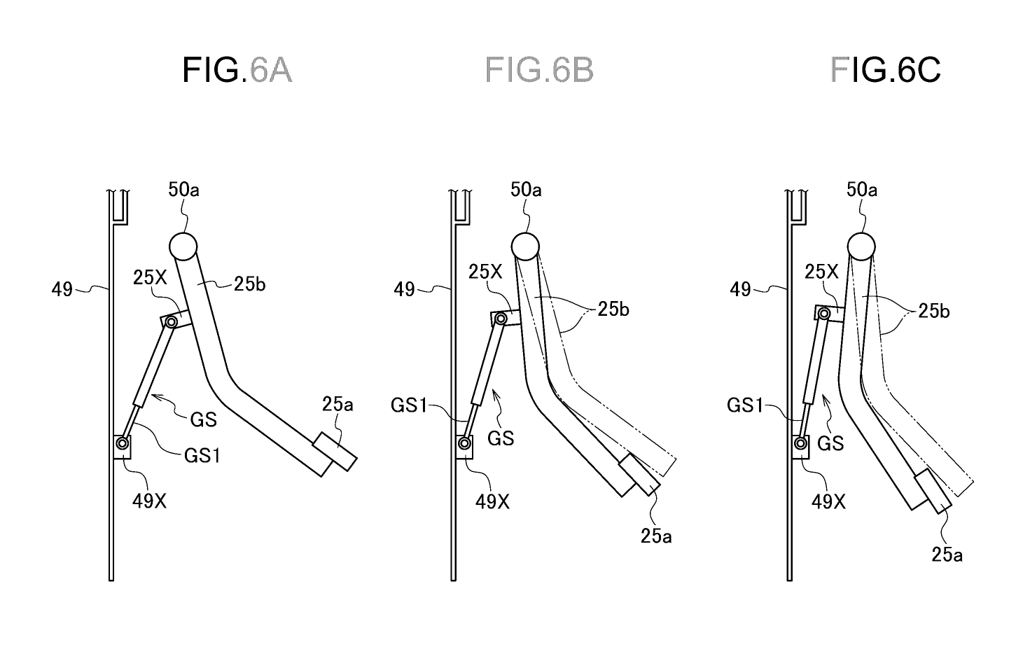

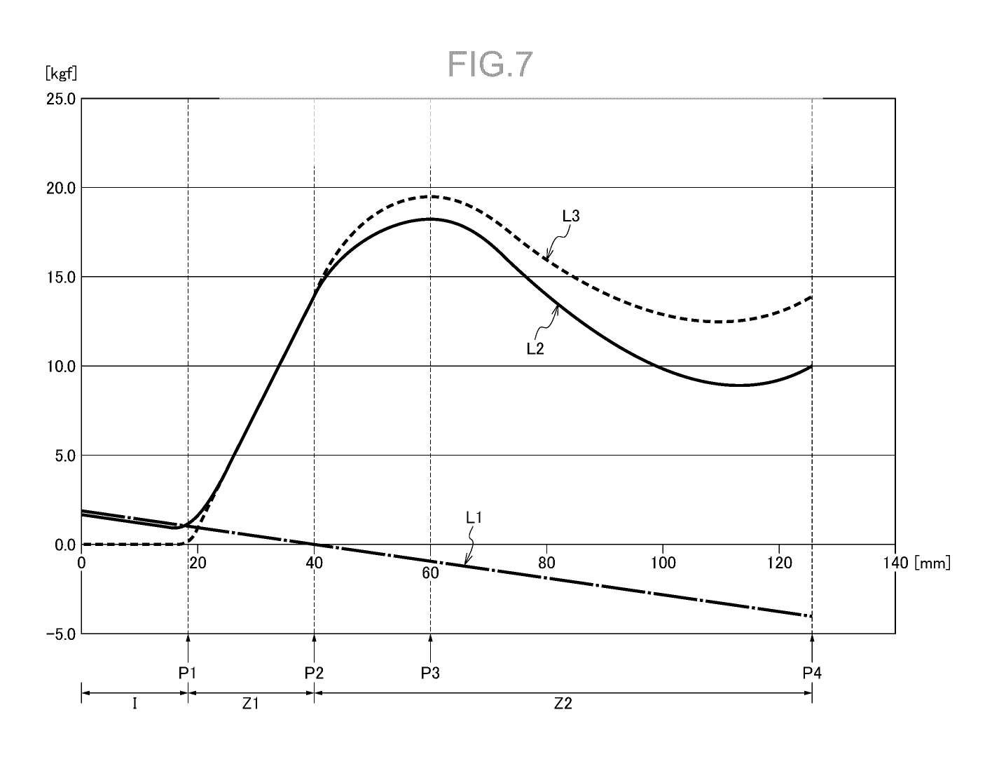

Next, the procedures of operating the clutch pedal 25 will be described by referring to FIGS. 6 and 7. In the graph illustrated in FIG. 7, the vertical axis represents the force amount (kgf) and the horizontal axis represents the depression amount (mm) of the pedal section 25a.

First, when a driver puts the left foot on the pedal section 25a and starts depressing it, the arm portion 25b rotates clockwise about the left end portion 50a of the cylinder as a support point of rotation in FIG. 6A. In response to this, a rod portion GS1 of the gas spring GS starts reducing. For some time after the start of depression of the clutch pedal 25 (stroke slightly before 20 mm in FIG. 7), an idling period (indicated by the period I in FIG. 7) is provided, where the counterforce of the gas spring GS acts in a direction to press back the clutch pedal 25 in a counterclockwise direction. Thus, it is possible to prevent erroneous depression of the clutch pedal 25, and also give an alert to the driver by the counterforce of the gas spring GS when the driver is going to depress the clutch pedal 25 by mistake.

Following the idling period (position P1 in FIG. 7), the link mechanism of the clutch pedal 25 starts acting to separate a clutch disk in the transmission case TM (indicated by the period Z1 in FIG. 7). In the period Z1, the counterforce applied by the gas spring GS to the clutch pedal 25 is smaller than that in the period I. When the clutch pedal 25 is further depressed, a distance between centers of the through hole 25XH of the stay 25X and the through hole 49XH of the bracket 49X becomes the shortest (indicated by position P2 in FIG. 7, FIG. 6B). In the periods I and Z1, the distance between the centers of the through hole 25XH of the stay 25X and the through hole 49XH of the bracket 49X gradually decreases. Up to the position P2 (first predetermined position), the gas spring GS acts in a direction to press back the arm portion 25b.

Beyond the position P2 (period Z2 in FIG. 7), the direction of the rod portion GS1 of the gas spring GS switches from a shrinking direction to an expanding direction (FIG. 6C). Specifically, the distance between the centers of the through hole 25XH of the stay 25X and the through hole 49XH of the bracket 49X gradually increases to allow the gas spring GS to apply assist force (i.e., negative counterforce) to the clutch pedal 25. Therefore, the driver can depress the clutch pedal 25 with a lighter force than before, which makes the operation more comfortable. Specifically, after going over the position P2 (first predetermined position), the gas spring GS acts in a direction of pressing the arm portion 25b.

In FIG. 7, when reaching position P3 (second predetermined position), the clutch disk in the transmission case TM is separated (i.e., transmission of the drive force from the engine to the drive wheels is disconnected). When the clutch pedal 25 is depressed to or beyond the position P3, a main shift lever is operated to change the gear of the transmission case TM and the left foot is removed from the clutch pedal 25. Meanwhile, if the clutch pedal 25 is excessively depressed from the position P3, the depression of the clutch pedal 25 is blocked by the stopper arm 60 and the clutch stopper 61 (position P4 in FIG. 7).

In the timing chart of FIG. 7, the force of the gas spring GS is indicated by a reference sign L1, the pedaling force of the clutch pedal 25 is indicated by a reference sign L2, and the pedaling force of the clutch pedal 25 needed while the gas spring GS is not used is indicated by a reference sign L3. As apparent from FIG. 7, the pedaling force of the clutch pedal 25 can be reduced in the period Z2 by the use of the gas spring GS.

The position of the stay 25X of the clutch pedal 25 is not limited to the above case, and may be arranged at any intermediate position of the arm portion 25b.

The gas spring GS described above may be replaced by a coil spring (elastic member) attached between the stay 25X and the bracket 49X.

Also, in the above case, the lower end of the gas spring GS is attached to the bracket 49X of the air cut plate (shielding) 49, but it is not limited thereto, and may be attached to any member (such as the chassis 14, the transmission case TM, or the braking mechanism B) serving as a constituent member of the machine body of the tractor 10. The lower end of the gas spring GS may not be attached directly to the constituent member of the machine body, and may be attached via the stay or bracket.

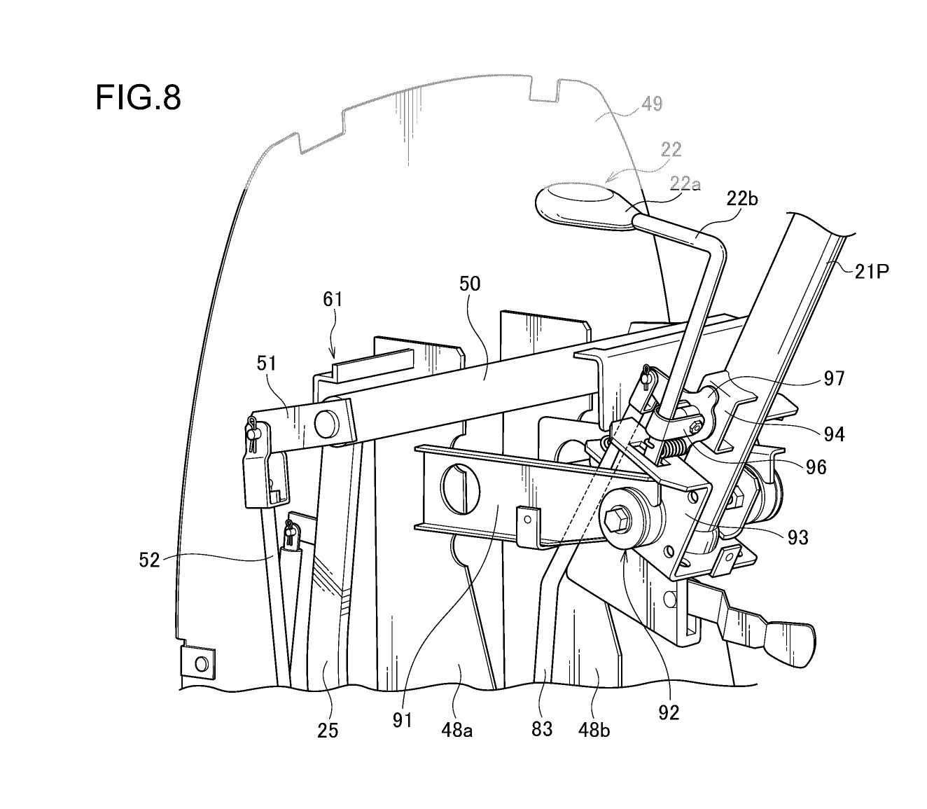

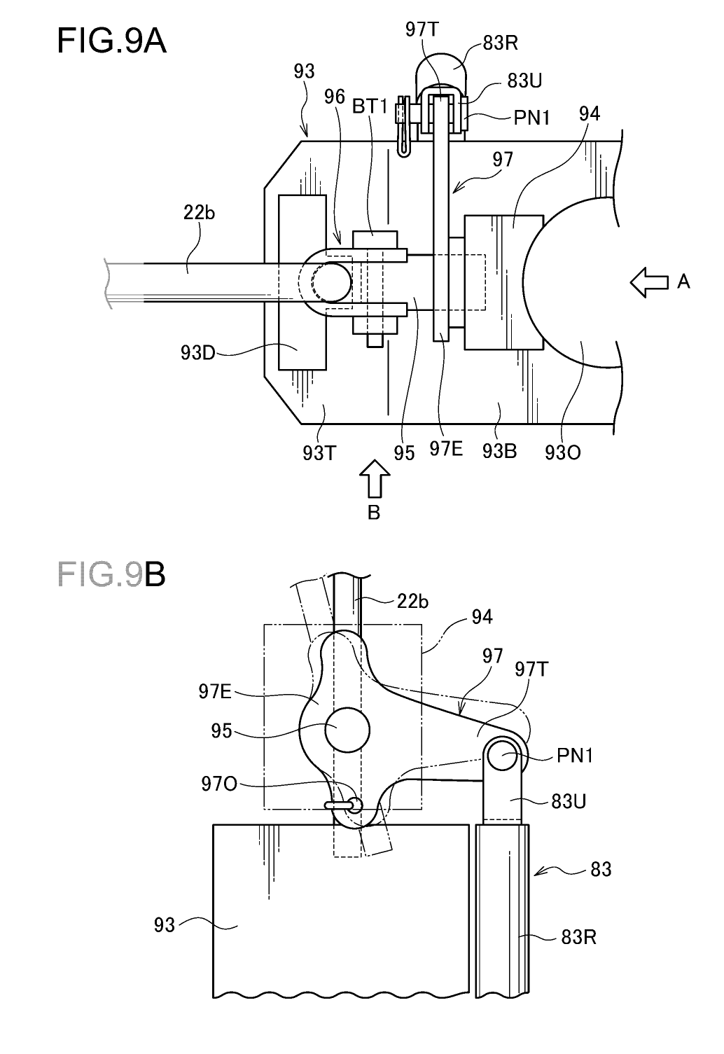

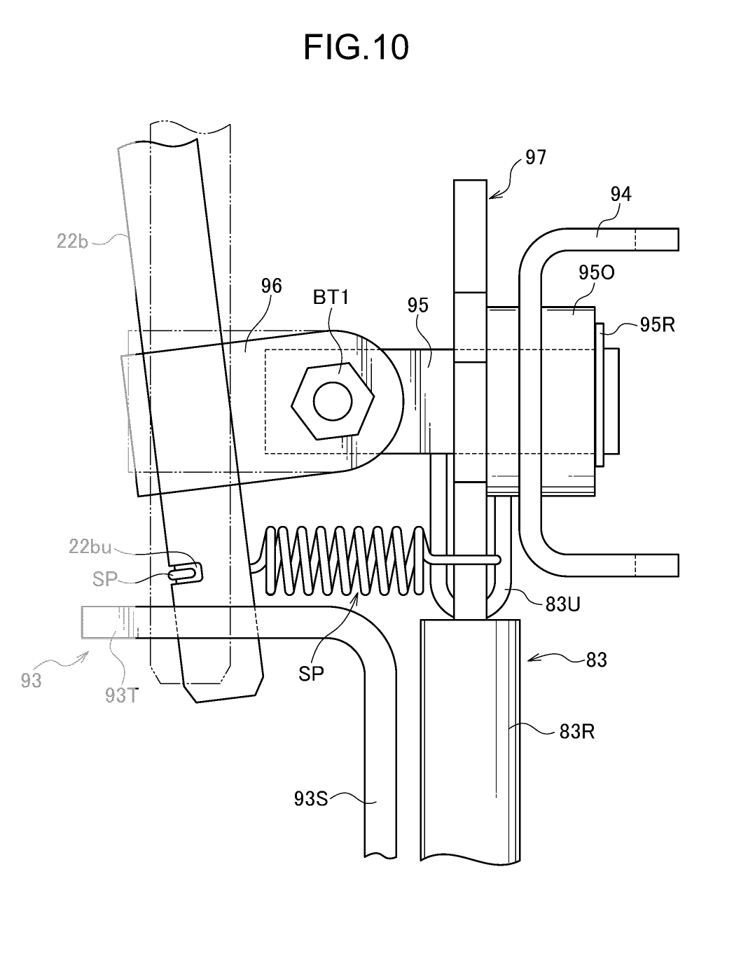

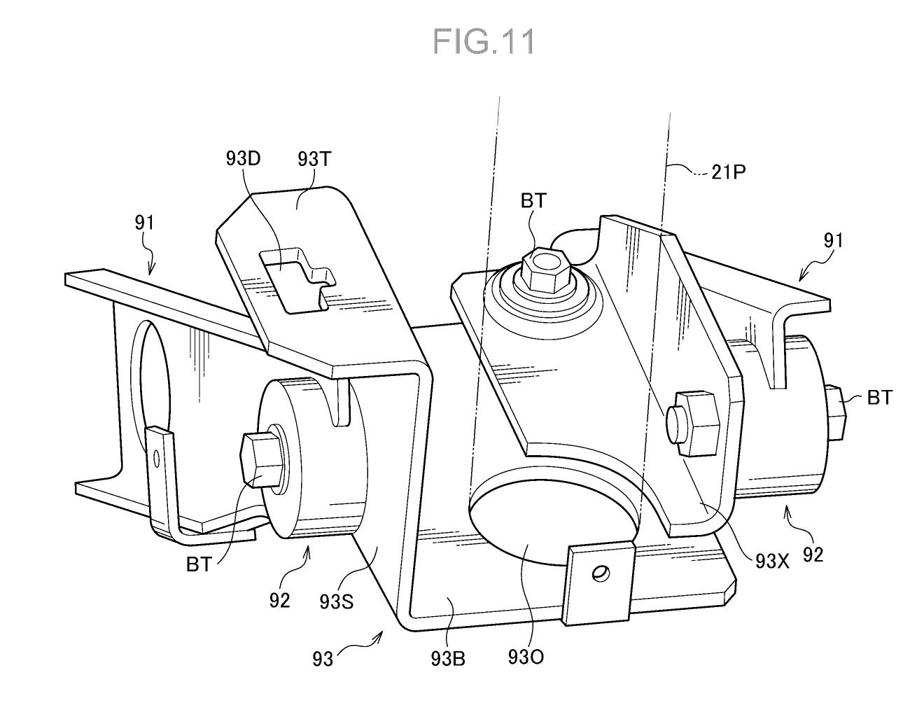

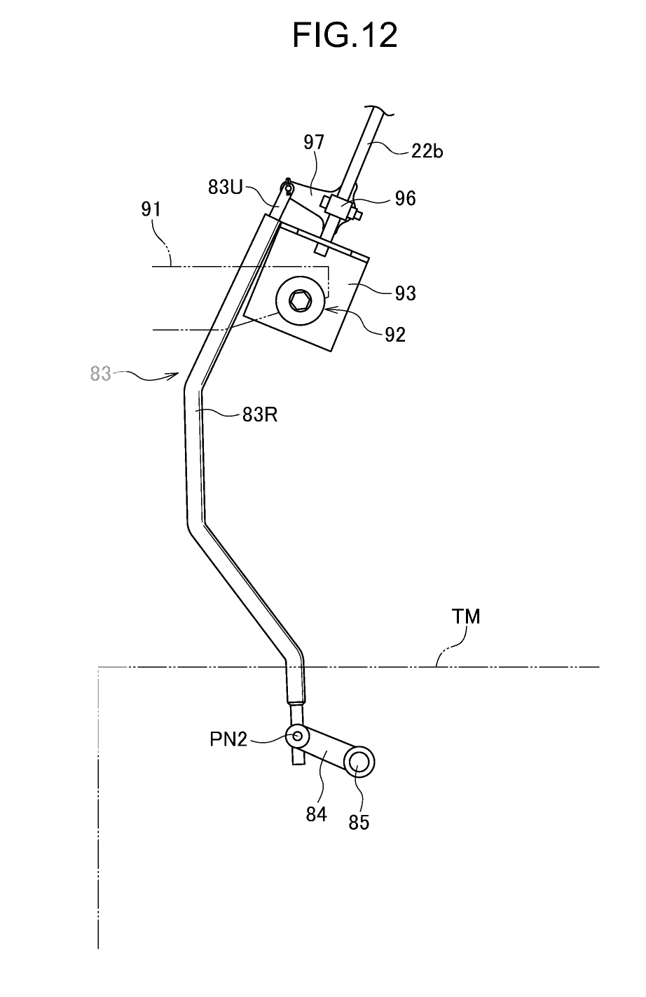

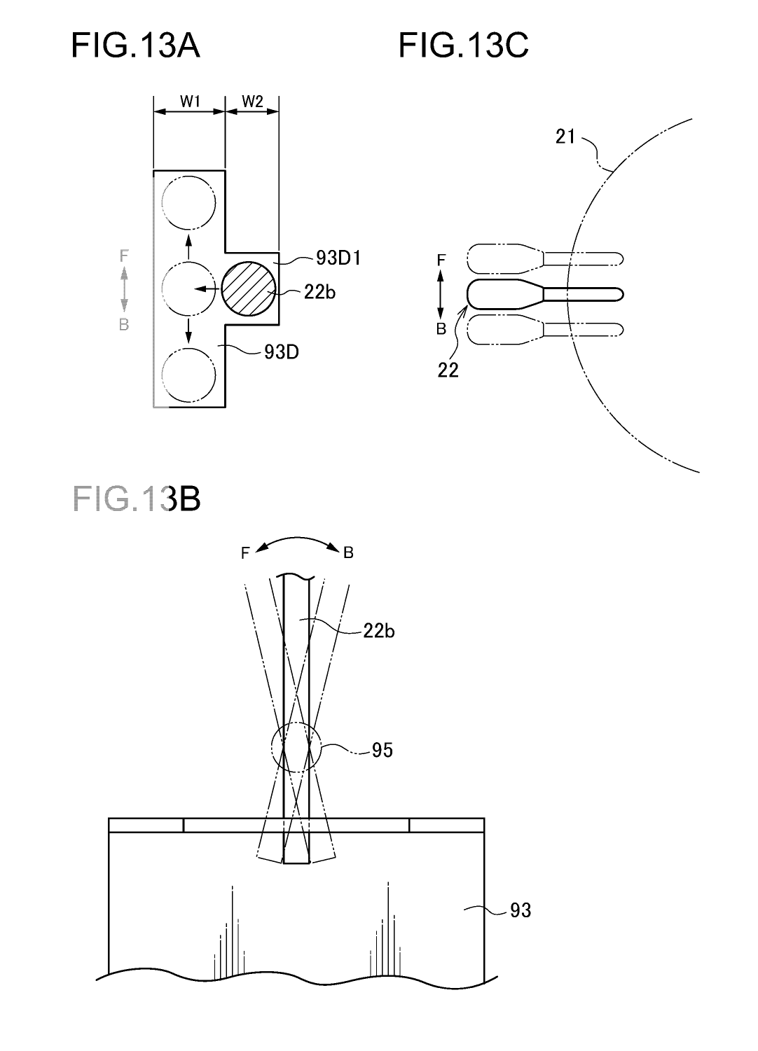

Next, the link means of the reverser lever will be described. FIG. 8 is a perspective view illustrating how the reverser lever is attached. FIG. 9A is a plan view for explaining how the reverser lever is connected to a reverser lever link, and FIG. 9B is a side view when seen from a direction of an arrow A of FIG. 9A. FIG. 10 is a side view when seen from a direction of an arrow B of FIG. 9A for explaining how the reverser lever is connected to the reverser lever link. FIG. 11 is a perspective view of a post supporting member which supports a steering post from below. FIG. 12 is an explanatory view illustrating how the reverser lever, the reverser lever link, the operation arm, and the transmission case are connected to each other. FIG. 13A is a plan view for explaining the shaft part of the reverser lever put in a guide hole of the reverser lever, FIG. 13B is a side view thereof, and FIG. 13C is a schematic plan view for explaining a positional relation between the reverser lever and the steering wheel.

As illustrated in FIG. 8, the reverser lever 22 causes a rotation shaft 85 to rotate via a reverser lever link 83 and an operation arm 84, in order to switch a forward and backward movement gear in the transmission case TM. Accordingly, the movement of the tractor 10 is switched between forward and backward movements.

Next, the main portion of the present example will be described by referring to FIGS. 8 to 10. The reverser lever 22 is constituted by a grip portion 22a and a shaft portion 22b. The grip portion 22a is made of resin and has a rear end to which the tip end of the shaft portion 22b is fitted. The shaft portion 22b is made from a metal round rod by folding it in an L shape, and a connecting member 96 is fixedly attached to the lower part thereof by welding. The lower end of the shaft portion 22b is inserted into a guide hole 93D formed in a post supporting member 93.

The connecting member 96 is formed by bending a metal plate in a U shape and, to the inside the curved portion, the lower portion of the shaft portion 22b is fixedly attached. Through holes are formed on both ends of the connecting member 96 to be connected rotatably with the rotation member 95 by a bolt BT1. The rotation member 95 is made from a metal column with one end being notched on both sides to form a planar portion. A through hole is formed in the planar portion. The connecting member 96 is arranged such that the internal surface thereof abuts against the planar portion. The through hole of the connecting member 96 is aligned with the through hole of the planar portion of the rotation member 95, through which the bolt BT1 is inserted to rotatably connect the connecting member 96 with the rotation member 95. By providing the planar portion on the rotation member 95 and having the internal surface of the plate-like connecting member 96 abut against the planar portion, the connecting member 96 and the rotation member 95 can be securely combined and rotated when the reverser lever 22 is rotated, which will be described later.

The other end of the rotation member 95 is rotatably supported by a supporting member 94. The supporting member 94 is made from a metal plate by bending it into a gate-like shape. The supporting member 94 is machined to follow the shape of the side face of a cylindrical steering post 21P and then fixed to the side face of the steering post 21P by welding. The other end of the rotation member 95 is attached to the supporting member 94 via a sleeve member 95O. The sleeve member 95O is made from a metal cylinder which is fitted in the through hole formed in the supporting member 94 and fixed to the supporting member 94 by welding. The rotation member 95 can rotate relative to the sleeve member 95O. Meanwhile, a retainer ring 95R is attached at the end of the rotation member 95 to prevent it from being slipped from the sleeve member 95O.

A link member (link means) 97 is fitted at the center portion of the rotation member 95, i.e., between the supporting member 94 and the connecting member 96. Accordingly, the center line of the rotation member 95 becomes the support point of rotation of the link member 97. The link member 97 is formed by machining a metal plate to have a narrow tip end 97T. A through hole is formed in the tip end 97T to rotatably connect with the reverser lever link 83 by a pin PN1. The reverser lever link 83 is formed by an upper attaching portion 83U and a rod portion 83R. The attaching portion 83U is formed by bending a metal plate into a U shape and with the open part thereof fixed facing upward to the rod portion 83R by welding. A through hole is formed at the upper end of the attaching portion 83U. The tip end 97T of the link member 97 is pinched by the attaching portion 83U and both members are rotatably attached by the pin PN1. A retainer pin is attached on the tip end of the pin PN1.

A recess 22bu is formed at the lower end portion of the shaft portion 22b. Meanwhile, a through hole 970 is formed in the lower portion of the rear end portion 97E of the link member 97. A coil spring SP is hooked between the recess 22bu and the through hole 970. Since the connecting member 96 can rotate relative to the rotation member 95, the lower portion of the shaft portion 22b is energized toward the link member 97 side with the bolt BT1 serving as the support point. The lower end of the shaft portion 22b is inserted into the guide hole 93D, such that the lower portion of the shaft portion 22b can move within the range of the guide hole 93D. FIG. 9B illustrates a state where the shaft portion 22b is in a notch (reference sign 93D1 in FIG. 13A) formed in the center of the guide hole 93D. This state is regarded as a neutral position of the reverser lever 22.

A pair of attaching members 91, 91 is extendingly provided to the brackets 48a, 48b fixedly attached to the air cut plate 49. A column member 92 is attached by welding at the tip end of each attaching member 91. The column member 92 is formed as a column-shaped metal member having a through hole in the center.

As illustrated in FIG. 11, the post supporting member 93 is attached to the column members 92, 92 via the bolt BT. The post supporting member 93 is constituted by a first body portion and a second body portion 93X. The first body portion includes a top portion (guide portion) 93T, a side portion 93S, and a bottom portion 93B, which are formed continuously. The first body portion and the second body portion 93X are connected by the bolt BT. The first body portion is formed by bending a metal plate at two locations. The guide hole 93D is formed in the top portion 93T. A through hole 930 for passing the shaft in the steering post 21P is formed in the bottom portion 93B.

The post supporting member 93 is attached to the pair of attaching members 91, 91 at a predetermined angle (see FIGS. 8 and 11). Specifically, the attaching members 91, 91 are provided generally horizontally, while the post supporting member 93 is tilted toward the driver seat 27 side. This is because the steering post 21P should be tilted toward the driver seat 27 side. By loosening the bolts BT that fasten the column members 92 and the post supporting member 93, it is possible to appropriately adjust an extent to which the post supporting member 93 may be tilted from the horizontal state.

The rod portion 83R of the reverser lever link 83 is formed by bending a column at three locations. The lower end portion of the rod portion 83R is machined into a plate-like portion in which a through hole is formed. This through hole is aligned with the through hole formed in one end of the operation arm 84 and rotatably connected together by a pin PN2. Another through hole is formed in the other end of the operation arm 84 to which one end of the rotation shaft 85 is fixed. The other end of the rotation shaft 85 is arranged in the transmission case TM.

In the tractor 10 formed as above, a method of operating the reverser lever 22 will be described by referring to the drawings up to FIG. 12 and using FIGS. 13A to 13C. In the neutral position, the shaft portion 22b of the reverser lever 22 is placed in the notch 93D1 of the guide hole 93D. In this state, the forward and backward movements of the reverser lever 22 is locked.

If it is desired to advance the tractor 10, a driver first grasps the grip portion 22a with the left hand and pulls down the reverser lever 22 in a direction closer to the steering wheel 21 (the shaft portion 22b indicated by a two-dot chain line in FIG. 10). Since the shaft portion 22b is energized by the coil spring SP, the driver pulls down the reverser lever 22 against the energizing power of the coil spring SP. Thus, the shaft portion 22b is released from the notch 93D1.

The reverser lever 22 is then pulled down in a forward direction (direction F in FIG. 13). Accordingly, the tip end 97T of the link member 97 rotates downward to press down the reverser lever link 83. The operation arm 84 then rotates downward to cause a forward gear to be engaged with the gear of the output shaft from the engine E via the reverser clutch (forward and backward movement switching means) in the transmission case TM.

In this state, if it is desired to stop the tractor 10 and turn off the engine, the reverser lever 22 is returned in a reverse direction (direction B in FIG. 13). The reverser lever 22 is returned until it reaches the neutral position. The tip end 97T of the link member 97 then rotates upward to pull up the reverser lever link 83. Accordingly, the operation arm 84 rotates upward to be in the neutral state where no transmission is allowed from the output shaft of the engine to the drive wheels in the transmission case TM. If the hand is released from the reverser lever 22 in this position, the lower portion of the shaft portion 22b is put in the notch 93D1 by the energizing power of the coil spring SP to lock the movement of the reverser lever 22 in both forward and backward directions (directions F and B) (which is regarded as the neutral position).

If it is desired to reverse the tractor 10 from this state, the driver grasps the grip portion 22a of the reverser lever 22 with the left hand, and pulls down the reverser lever 22 in a direction closer to the steering wheel 21 (the shaft portion 22b indicated by the two-dot chain line in FIG. 10). Since the shaft portion 22b is energized by the coil spring SP, the driver pulls down the reverser lever 22 against the energizing power of the coil spring SP.

The reverser lever 22 is then pulled down in a backward direction (direction B in FIG. 13) (indicated by a two-dot chain line of the shaft portion 22b in FIG. 9B). The tip end 97T of the link member 97 then rotates upward to pull up the reverser lever link 83. The operation arm 84 then rotates upward to cause the backward gear to be engaged with the gear of the output shaft via the reverser clutch (forward and backward switching means) in the transmission case TM.

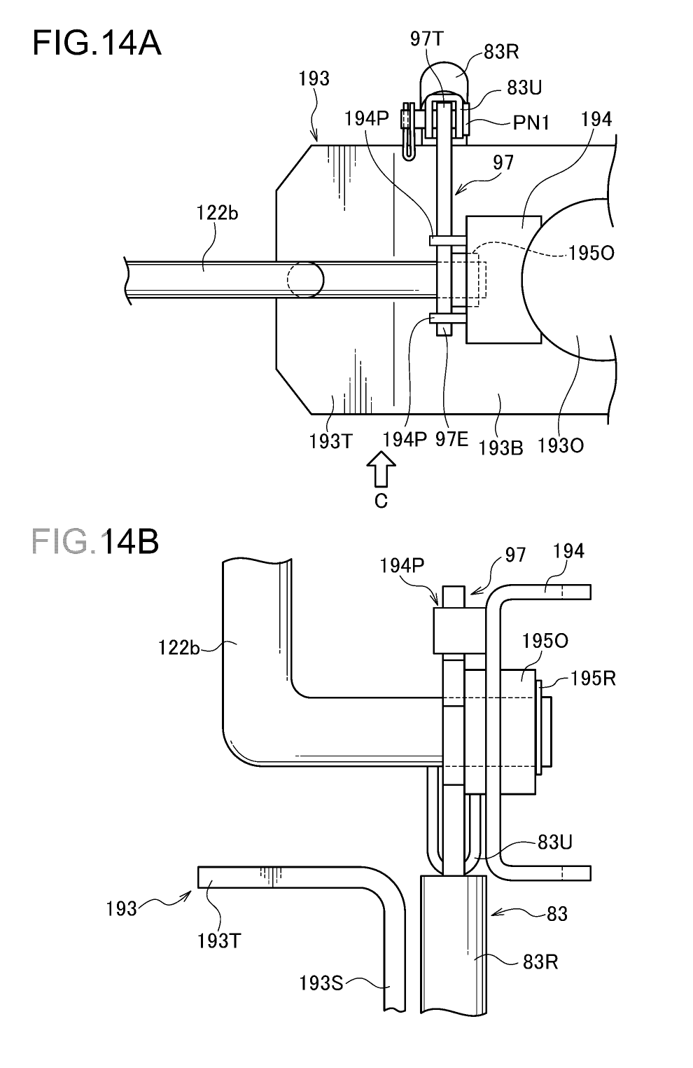

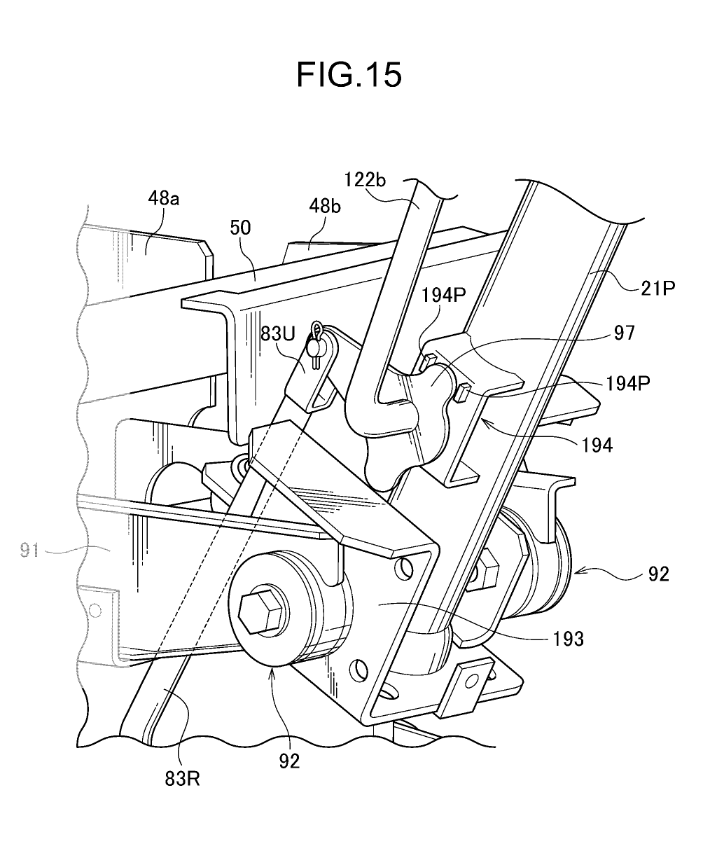

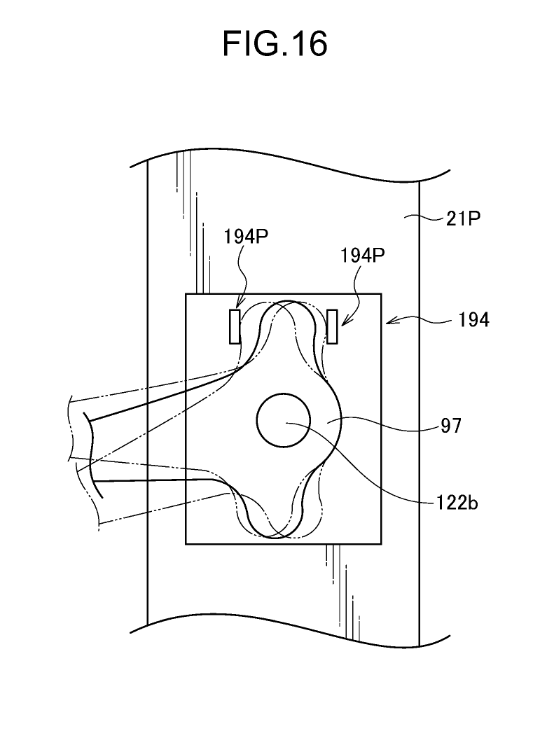

The shaft portion 22b of the reverser lever 22 may be formed as illustrated in FIGS. 14 and 15. FIG. 14A is a plan view illustrating a main part of another example of the reverser lever, and FIG. 14B illustrates a side view when seen from an arrow C of FIG. 14A. FIG. 15 is a perspective view illustrating a main part of another example of the reverser lever. FIG. 16 is an explanatory view illustrating how a stopper restricts rotation of a link member.

Specifically, the reverser lever is constituted by a grip portion (which is not shown and identical to the grip portion 22a) and a shaft portion 122b. The shaft portion 122b is made from a metal round rod having the upper and lower parts thereof opposite to each other bent at a generally right angle.

An end of the shaft portion 122b is rotatably supported by a supporting member 194. The supporting member 194 is made from a metal plate by bending it into a gate-like shape. The supporting member 194 is machined to follow the shape of the side face of the cylindrical steering post 21P and then fixed to the side face of the steering post 21P by welding. The end of the shaft portion 122b is attached to the supporting member 194 via a sleeve member 195O. The sleeve member 195O is made from a metal cylinder which is fitted in the through hole formed in the supporting member 194 and fixed to the supporting member 194 by welding. The end of the shaft portion 122b can rotate relative to the sleeve member 195O. Meanwhile, a retainer ring 195R is attached at the end of the shaft portion 122b to prevent it from being slipped from the sleeve member 195O.

The shaft portion 122b penetrates through and fixedly attached to the link member 97 by welding or the like, and can be combined and rotated with the shaft portion 122b. The support point of the link member 97 is the center line of the shaft portion 122b.

Two stoppers 194P project on the surface of the supporting member 194. The stoppers 194P are configured to restrict the movement of the link member 97 when the shaft portion 122b rotates. When the link member 97 rotates forward, i.e., when the reverser lever is pulled down in a forward direction, it abuts against the front stopper 194P. Meanwhile, when the link member 97 rotates backward, i.e., when the reverser is pulled down in a backward direction, it abuts the rear stopper 194P (see FIG. 16). In this structure, the rotation member 95, the connecting member 96, and the connecting bolt BT1 are eliminated, and the number of necessary parts can be reduced. Further, the post supporting member 93 can be formed easily, as the guide hole 93D in the post supporting member 93 is not necessary.

The present invention is not limited to the above embodiments. Instead, it can be implemented in any form without departing from the scope of the present invention.

### INDUSTRIAL APPLICABILITY

Application of the vehicles according to the embodiments of the present invention is not limited to tractors. Instead, the present invention is applicable to other farm work vehicles (such as a combine, a rice transplanter, or a lawn more), vehicles having a clutch, such as a car, a truck, and a construction work vehicle (such as a backhoe or a bulldozer), a folk lift, and so on.

### REFERENCE SIGNS LIST

10 Tractor (vehicle)
11 Bonnet
25 Clutch pedal
25a Pedal section
25b Arm portion
27 Driver seat
49 Air cut plate (shielding)
GS Gas spring (elastic member)
TM Transmission case
P2 Position (first predetermined position)
P4 Position (second predetermined position)

1. A vehicle including a clutch pedal which, when depressed, interrupts transmission of drive power from an engine to drive wheels, wherein
the clutch pedal includes a pedal section and an arm portion having the pedal section attached to the lower part thereof,
the arm portion is rotatable about the upper part thereof and is connected to a clutch disk within a transmission through a link mechanism, and
an elastic member is provided between the arm portion and a machine body, wherein
when the clutch pedal is depressed, the elastic member acts in a pressing-back direction until the clutch pedal reaches a first predetermined position, the pressing-back direction being the direction in which the elastic member presses back the arm portion,
when the clutch pedal is depressed beyond the first predetermined position, the elastic member acts in the direction in which the arm portion is pressed in; and
when the clutch pedal is depressed up to a second predetermined position, the clutch disk is separated,
one end of the elastic member is mounted to the intermediate position of the arm portion, and the other end of the elastic member is mounted to the machine body.

2. The vehicle according to claim 1, wherein
a shielding is provided at the rear end of a bonnet for separating the bonnet from a driver, and the other end of the elastic member is attached to the shielding.

3. The vehicle according to claim 2, wherein
the shielding is provided with an attaching member including a forward and backward movement switching lever that switches between forward and backward operations of the vehicle via link means is provided,
the forward and backward movement switching lever is provided with operation means for driving forward and backward switching means in a mission case, wherein
when the forward and backward switching means is driven, the link means is enabled to rotate in a forward or backward direction of the vehicle about a support point of rotation.
